(19) United States
(12) Patent Application Publication
(10) Pub. No.: US 2011/0279651 A1
(43) Pub. Date: Nov. 17, 2011

(54) Method and Apparatus for Auto-Convergence Based on Auto-Focus Point for Stereoscopic Frame

(75) Inventors: Wei Hong, Sunnyvale, CA (US); Mark N. Gamadia, Longmont, CO (US); Gregory Robert Hewes, Sachse, TX (US); Fred William Ware, JR., Carrollton, TX (US)

(73) Assignee: TEXAS INSTRUMENTS INCORPORATED, Dallas, TX (US)

(21) Appl. No.: 13/099,582

(22) Filed: May 3, 2011

Related U.S. Application Data
(60) Provisional application No. 61/345,243, filed on May 17, 2010.

(51) Int. Cl. H04N 13/02

(52) U.S. Cl. 348/47; 348/E13.074

(57) ABSTRACT

A method and apparatus for performing auto-convergence on a frame of a stereoscopic image or video based on at least one auto-focus point. The method includes retrieving a location of focus points from the image, estimating the disparity of focus points in the image, determining the disparity of the frame for the stereoscopic image or video, and shifting the frame to automatically adjust the convergence of the fame for the stereoscopic image or video.

### CROSS-REFERENCE TO RELATED APPLICATIONS

This application claims benefit of U.S. provisional patent application Ser. No. 61/345,243, filed May 17, 2010, which is herein incorporated by reference.

### BACKGROUND OF THE INVENTION

1. Field of the Invention

Embodiments of the present invention generally relate to a method and apparatus for auto-convergence based on auto focus point of stereoscopic frame.

2. Description of the Related Art

In human visual systems or stereoscopic camera systems, the point of intersection of the two eye axes or two camera axes is the convergence point. The distance from the convergence point to the eye or camera is the convergence distance. For human eyes, the convergence point can be at any arbitrary distance, as the eyes manually verge upon where you are gazing. For stereoscopic cameras, the convergence point is either at infinity (for parallel camera configuration) or at a fixed distance (for toe-in camera configuration). When people want to look at a stereoscopic image or video on a stereoscopic display, their eyes naturally converge to the display screen. The distance from the display screen to the eyes is the natural convergence distance. In order to view the 3D effect correctly, viewers naturally adjust their eyes to have the same convergence distance as the camera. If the main objects of interest are very different from the convergence distance, then your eyes will not be able to converge on the display to focus on the objects (the convergence plane will be rendered to the display plane) Such constant convergence distance adjustment may cause discomfort, headache or eye muscle pain over time.

Hence, there is a need for an improved auto-convergence method and apparatus to improve visual comfort.

### SUMMARY

Embodiments of the present invention relate to a method and apparatus for performing auto-convergence on a frame of a stereoscopic image or video based on at least one auto-focus point. The method includes retrieving a location of focus point in the image, estimating a disparity of focus point of the image, determining the disparity of the frame of the stereoscopic image or video, and shifting the frame to automatically adjust the convergence of the fame of the stereoscopic image or video.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a method for auto-convergence based on auto-focus for stereoscopic frames;

FIG. 2 depicts autofocus (AF) windows and focus points;

FIG. 3 depicts disparities for each block and the disparities of focus points of FIGS. 2; and

FIG. 4(a) is an embodiment of a stereoscopic image before auto-convergence and FIG. 4(b) is an embodiment of a stereoscopic image after proposed auto-convergence.

### DETAILED DESCRIPTION

To improve visual comfort, the convergence distance of the stereoscopic image/video is usually adjusted so that the convergence distance of the stereo image/video will be the same or close to the natural convergence distance of our eyes to ensure a comfortable viewing. To adjust the convergence distance, the left frame and the right frame need to be shifted by certain amount. The auto-convergence method we propose in this invention will determine the amount of shifting automatically.

When people look at an object, they usually focus on an object and their eyes converge to the same object. Thus, the convergence distance of the eyes is the same as the focus distance of the eyes. Since the objects at the convergence distance must have zero disparity, the objects at focus distance should also have zero disparity for human eyes. But for a stereoscopic image or video captured by a camera, the objects at focus distance may have non-zero disparity because the convergence point of the camera is fixed at either infinity or a certain distance. Therefore, we need to adjust the convergence so that the disparity of the focused objects is zero.

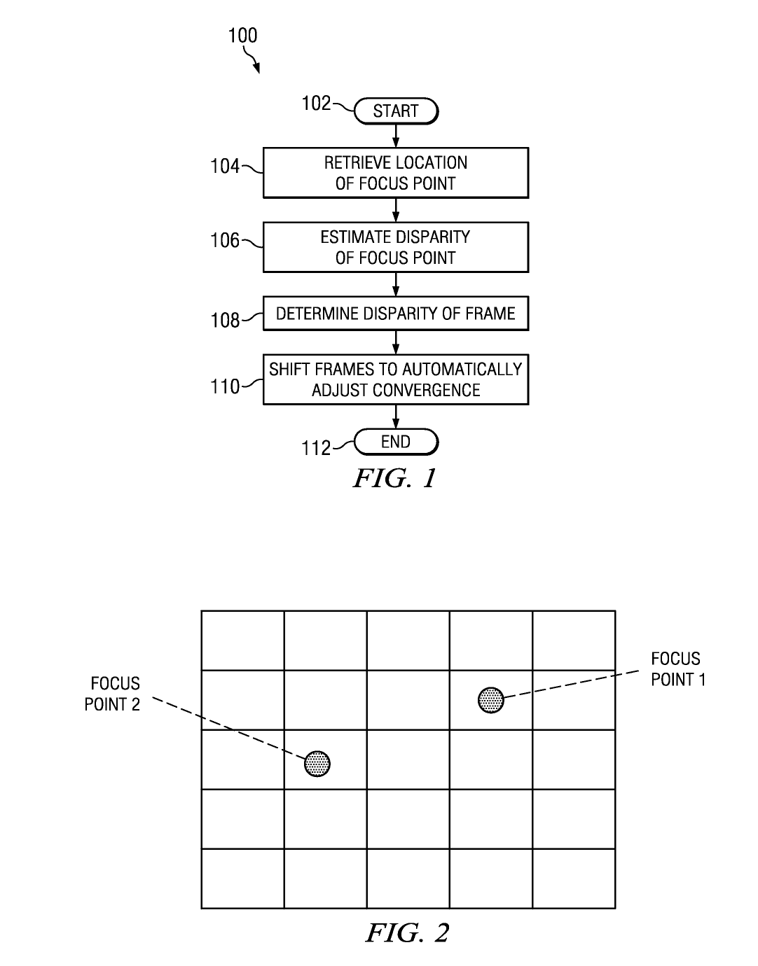

FIG. 1 depicts an embodiment for a method 100 for auto-convergence based on auto-focus for stereoscopic frames. The method 100 begins at step 102. At step 104, the method 100 retrieves location of a focus point. At step 106, the method 100 estimates disparity of focus point. At step 108, the method 100 determines disparity of the frame. At step 110, the method 100 horizontally shifts the frames to automatically adjust the convergence of the frame of a stereoscopic image or video.

The first step is to retrieve the location of the focus point. For example, the method 100 may retrieve the location of the focus point on the left frame from the auto-focus system. FIG. 2 depicts autofocus (AF) windows and focus points. The focus point is the location of the object on which the camera is focused. Normally, autofocus of the left camera divides the left frame into a matrix grid of AF windows of equal size. The location of the focus point is described as an index of autofocus window (AF window). As shown in FIG. 2, we have 25 AF windows as a 5×5 grid in this example. If there are multiple focus points on the frame, we get multiple indices of focused AF windows. FIG. 2 shows an example of 5×5 AF windows with 2 focus points. We can also get the location of the focus points from the right frame or from both left and right frames.

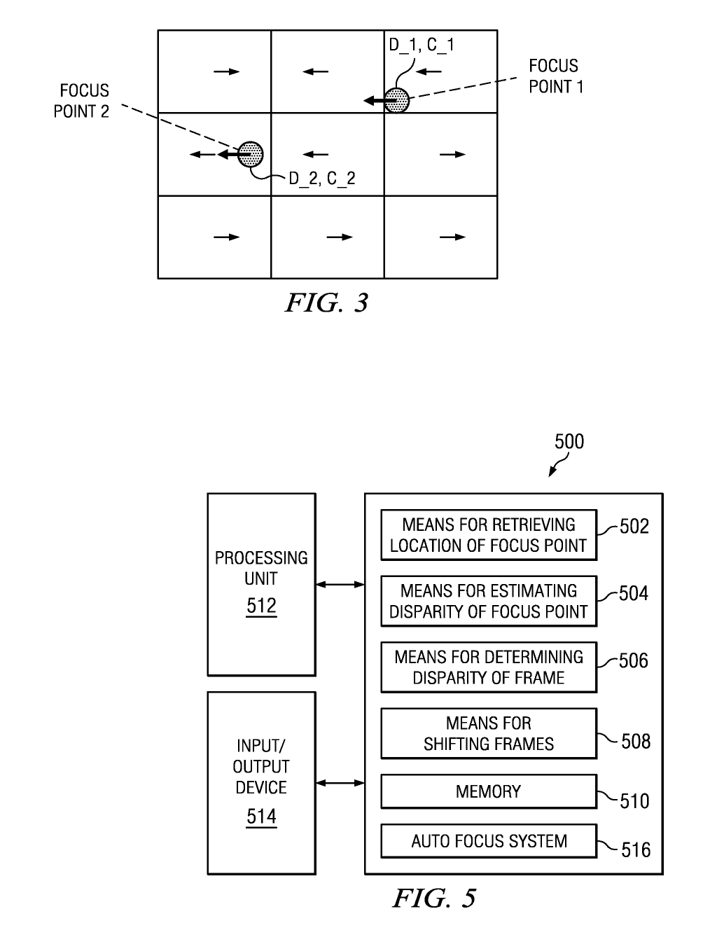

The next step is to estimate the disparity of focus point. FIG. 3 depicts disparities for each block and the disparities of focus points of FIG. 2. The disparity value of a focus point can be estimated using any block-based disparity estimation method. The number and size of the block of the block-based disparity estimation can be equal or not equal to the number and size of the AF window we used in step 1. After the disparity estimation, we get a disparity value D and a confidence value C for every block. The confidence value of each block describes how accurate the disparity estimation is in this block and ranges from 0 to 1. If the focus point is not at the center of a block, nearest-neighbor or bi-linear interpolation is used to get the disparity value and the confidence value for the focus point. In the example in FIG. 2, Focus point 1 and Focus point 2 receives disparity values D_1 and D_2, and confidence value C_1 and C_2 respectively.

The next step is to determine the disparity of the frame. If there is only one focus point, the disparity of the frame is the disparity of the focus point D.

If there are multiple focus points (m is the number of focus points), the disparity of the frame is a weighted average of the disparities of all the focus points.

D=sum(D_{—}i*C_{—}i)/m

For the example in FIG. 3, the frame disparity D=(D_1*C_1+D_2*C_2)/2.

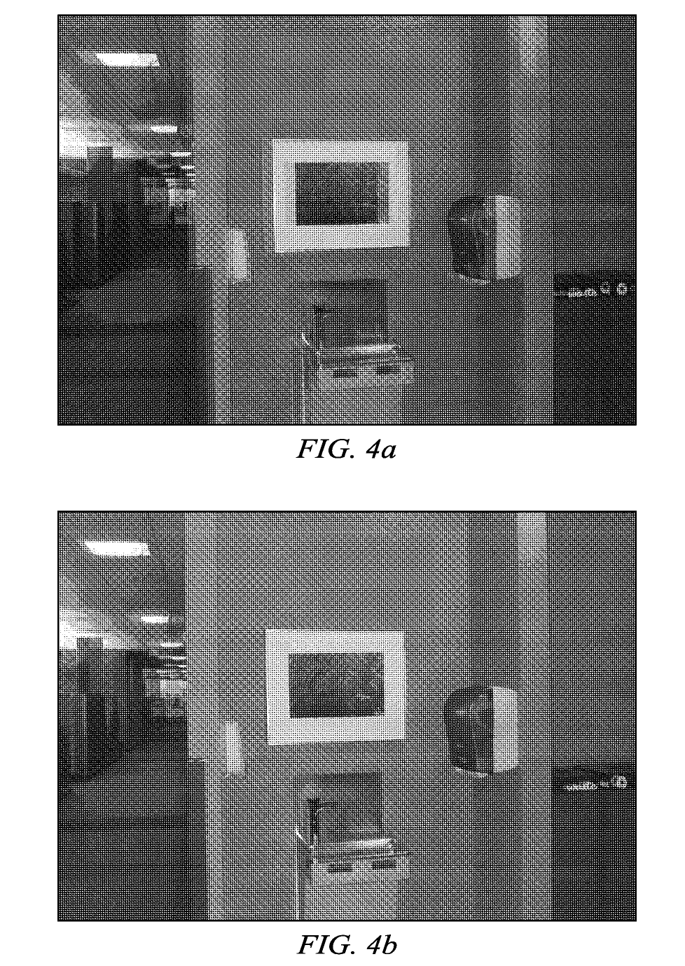

Then the method 100 performs step four, wherein the frames are shifted. For example, the frames may be shifted left and right. Once the frame disparity is determined, one can shift the left frame horizontally by D/2 and right frame by −D/2. After the shifting, the convergence distance will be the same as the focus distance. The disparity of the focused objects will be zero. FIG. 4 shows a stereoscopic image before and after the proposed auto-convergence method.

Apparatus that may utilize method 100 are, for example, an image capturing device, a camera, a camcorder, a hand-held device that incorporates a video or an image capturing device and the likes. FIG. 5 is an embodiment of an image capturing device 500. The image capturing device 500 includes means for retrieving location of focus point 502, means for estimating disparity of focus point 504, means for determining disparity of frame 506, means for shifting frames 508, memory 510, processing unit 512, input/output device 514 and an auto-focus system 516. Each of the means for retrieving location of focus point 502, means for estimating disparity of focus point 504, means for determining disparity of frame 506, and means for shifting frames 508 performs the related steps as outlined herein above.

The memory 510 may comprise non-transitory computer readable medium, random access memory, read only memory, removable disk memory, flash memory, and various combinations of these types of memory. The memory 510 is sometimes referred to main memory and may, in part, be used as cache memory or buffer memory. The memory 510 may store an operating system (OS), database software, various forms of application software. The processing unit 512 may utilize the memory 510 to perform any process needed to perform the auto-convergence. The input/output device 514 may be any device that, for example, is capable of capturing images or video or retrieving captured images or videos. The processing unit 512 and the input/out device 514 may be coupled, wirelessly communicating or included within the image capturing device 500. The auto-focus system 516 may be a system that determines the focus point or a system that maintains data relating to focus points.

While the foregoing is directed to embodiments of the present invention, other and further embodiments of the invention may be devised without departing from the basic scope thereof, and the scope thereof is determined by the claims that follow.

1. A method for performing auto-convergence on a frame of a stereoscopic image or video based on at least one auto-focus point, comprising:
retrieving a location of focus point in the image;
estimating a disparity of focus point of the image;
determining the disparity of the frame of the stereoscopic image or video; and
shifting the frame to automatically adjust the convergence of the fame of the stereoscopic image or video.

2. The method of claim 1, wherein the retrieving of the focus point retrieves the focus point of the left frame from an auto focus system.

3. The method of claim 1, wherein the sifting of the frame is a right and left shift.

4. An apparatus for image capturing and for performing auto-convergence on a frame of a stereoscopic image or video based on at least one auto-focus point, comprising:
means for retrieving a location of focus point in the image;
means for estimating a disparity of focus point of the image;
means for determining the disparity of the frame of the stereoscopic image or video; and
means for shifting the frame to automatically adjust the convergence of the fame of the stereoscopic image or video.

5. The apparatus of claim 3, wherein the retrieving of the focus point retrieves the focus point of the left frame from an auto focus system.

6. The apparatus of claim 3, wherein the sifting of the frame is a right and left shift.

7. A non-transitory computer readable medium comprising software that, when executed by a processor, causes the processor to perform a method for performing auto-convergence on a frame of a stereoscopic image or video based on at least one auto-focus point, comprising:
retrieving a location of focus point in the image;
estimating a disparity of focus point of the image;
determining the disparity of the frame of the stereoscopic image or video; and
shifting the frame to automatically adjust the convergence of the fame of the stereoscopic image or video.

8. The non-transitory computer readable medium of claim 7, wherein the retrieving of the focus point retrieves the focus point of the left frame from an auto focus system.

9. The non-transitory computer readable medium of claim 7, wherein the sifting of the frame is a right and left shift.
